(19) United States
(12) Patent Application Publication
(10) Pub. No.: US 2020/0253185 A1
(43) Pub. Date: Aug. 13, 2020

(54) SPRAY DEVICE

(71) Applicant: Robert Bosch GmbH, Stuttgart (DE)

(72) Inventors: Jochen Glasbrenner, Stuttgart (DE); Helmut Schomburg, Deufringen (DE); Olaf Ohlhafer, Erligheim (DE); Dieter Amesoeder, Ludwigsburg (DE); Hans-Arndt Freudigmann, Tuebingen (DE)

(21) Appl. No.: 16/760,771

(22) PCT Filed: Oct. 26, 2018
(86) PCT No.: PCT/EP2018/079372

§ 371 Date: Apr. 30, 2020

(30) Foreign Application Priority Data
Nov. 10, 2017 (DE) 10 2017 220 030.8

(51) Int. Cl. A01M 7/00; B05B 7/32; B05B 12/14; B05B 13/00

(52) U.S. Cl. CPC A01M 7/0092; B05B 7/32; A01M 7/0042; B05B 13/005; B05B 12/1418

(57) ABSTRACT

A spray device for deploying liquids, in particular for agricultural purposes. The spray device includes at least one spray nozzle for spraying the liquid and includes at least one mixing unit, which encompasses at least one mixing chamber. The mixing chamber includes at least one first inlet for a carrier liquid, at least one second inlet for an active agent liquid, and at least one outlet. The mixing unit encompasses at least one control member for setting a mixing ratio of carrier liquid and active agent liquid. The control member is rotatably mounted in the mixing chamber, a through-flow cross-section of at least the first inlet and/or the second inlet being set depending on the rotation position of the control member.

### FIELD

The present invention relates to a spray device for deploying liquids, in particular for agricultural purposes, including at least one spray nozzle for spraying the liquid and including at least one mixing unit, which encompasses at least one mixing chamber, the mixing chamber including at least one first inlet for a carrier liquid, at least one second inlet for an active agent liquid, and at least one outlet, and the mixing unit encompassing at least one control member for setting a mixing ratio of carrier liquid and active agent liquid.

### BACKGROUND INFORMATION

In the case of present-day agricultural plant protection measures, the spray mixture made up of at least one active agent, in particular an active agent liquid, such as a plant protection agent, as well as a carrier liquid, in particular water, must be premixed before the actual application onto a field. At the end of the application, the tank providing the particular agent generally must be completely emptied on the field and cleaned. It is therefore barely possible to respond to the condition of the field and to the actual local need for plant protection agent. The complete mixed spray mixture is therefore completely deployed on the field.

In some conventional systems, the active agent liquids are carried along, undiluted, in a separate tank and are mixed with the carrier liquid only as needed during the deployment onto the field. For this mixing process, it is necessary to be able to meter the active agent liquid together with the carrier liquid according to demand. This metering process is also referred to as direct feeding and requires a complex configuration of a spray device, which must provide valves, and the like, necessary therefor.

Spray devices of the type mentioned above are available in the related art. German Patent Application No. DE 10 2006 059 193 A1, for example, describes a spray device, which encompasses a mixing chamber, to which a carrier liquid as well as an active agent liquid, in particular a plant protection agent, are suppliable. In this case, it is provided to initially feed the active agent liquid into at least one bypass line for predilution, the bypass line containing the active agent prediluted with the carrier liquid emptying into a carrier liquid line leading to multiple spray nozzles. In order to affect the mixing or the ratio of carrier liquid and active agent liquid, multiple outlet valves or adjusting valves, activatable independently of one another and each including one valve element, as a control member, are present, which are located upstream from the liquid lines forming the mixing chamber.

One further conventional spray device, for example, is describe in German Patent Application No. DE 31 40 441 A1. This spray device includes a metering pump, which is designed as a piston pump, carrier liquid and active agent liquid being combined in the metering pump, so that the metering pump itself operates as a mixing unit including a mixing chamber and the pistons operate as control members.

Moreover, German Patent Application No. DE 39 08 963 A1 describes a spray device, including metering pumps, which pump the active agent liquid as well as the carrier liquid into a mixing chamber as necessary in a desired mixing ratio.

### SUMMARY

An example spray device in accordance with the present invention may have the advantage that a particularly compact mixing unit of the spray device is made available, which has a simple operation and a low likelihood of failure. In addition, due to its compact design, an installation space-saving embodiment is ensured, which also saves weight, so that it is easily possible to carry the mixing unit along with the spray device. For this purpose, the spray device according to the present invention provides that the control member is rotatably mounted in the mixing chamber, a through-flow cross-section of the first inlet and/or the second inlet being set depending on the rotation position of the, in particular, only one control member. Therefore, the mixing ratio is affected by a control member situated in the mixing chamber, whereby a particularly compact embodiment is achieved. Due to the rotary mounting of the control member, a simple adjustment of the desired through-flow cross-section of the first inlet and/or of the second inlet is settable. Optionally, a through-flow cross-section of the outlet is also settable via the rotation position. In addition, more than only two inlets may also be present and may be operated as described above with the aid of the control member.

In particular, in accordance with the present invention, it is provided that the control member is designed as a camshaft and that at least one of the inlets encompasses a valve actuatable with the aid of the camshaft. As a result, a particularly simple mechanical actuation of a valve assigned to the particular inlet is made possible. Conventional cam technologies may be accessed in this case, so that a low design complexity is necessary. In addition, a particularly robust and permanently functioning approach is provided via the mechanical actuation. In addition, due to the profile of the outer circumference of the camshaft, a chronological sequence of the opening behavior of the particular valve is settable, in order to ensure an optimal mixing.

According to one preferred refinement of the present invention, it is provided that the particular valve encompasses a valve element, which is movably mounted and spring-preloaded in the direction of the camshaft and rests tightly against a valve seat of the valve, closing the affected inlet, in a state in which it is not actuated by the camshaft. The particular valve therefore encompasses a movable valve element, which, in the normal state, or a state in which it is not actuated by the camshaft, rests against a valve seat in a sealing manner and, as a result, closes the affected or assigned inlet/access. By turning the camshaft, the valve element is displaced by the camshaft counter to the spring force, so that it assumes a distance to the valve seat, whereby the through-flow cross-section is released and active agent liquid or carrier liquid may flow through the access opened in this way. Due to the spring preload, it is ensured that the valve element always reliably returns to the valve seat and a forcible control for the valve element is present at the camshaft.

Moreover, it is preferably provided that a valve actuatable by the camshaft is assigned to multiple inlets in each case, in particular to each inlet of the spray device. The valve is designed as described above. As a result, with the aid of one and the same camshaft, multiple valves of the spray device or of the mixing unit are simultaneously actuatable, one valve being opened and another valve being closed depending on the rotation angle position of the camshaft. As a result, a simple and reliable actuation of all valves of the mixing unit is provided.

Moreover, it is preferably provided that the mixing unit encompasses two control members rotatably mounted in the mixing chamber, a separate, activatable control actuator, in particular, an electric motor, being assigned to each of the control members, in order to turn the particular control member. Due to the provision of at least two control members, sections of the mixing chamber—as viewed in the axial extension of the particular control member or in the longitudinal extension of the particular rotational axis—or existing valves and/or inlets and/or the outlet are actuatable independently of one another, so that an enhanced availability of the spray device is achieved.

It is particularly preferred when each of the two control members is designed as a camshaft, at least one of the valves, in particular, at least two of the valves in each case, being assigned to each camshaft. In addition, one valve may be assigned to one of the camshafts and two or more valves may be assigned to the other camshaft. This yields a variable mixing of different active agent liquids as well, which may be fed to a carrier liquid according to demand.

Preferably, the particular camshaft encompasses one cam in each case for the particular assigned valve. Due to the shape of the cam, the particular valve is actuated according to the rotation position of the camshaft.

Alternatively, the camshaft includes a shared cam for at least two assigned valves, the valves being situated next to one another or one behind the other as viewed in the direction of rotation of the cams. In an arrangement one behind the other, the valves are actuated one after the other, whereby the valves are settable having different through-flow cross-sections. If the valves are situated next to one another, however, as viewed in the circumferential direction, they are simultaneously actuated by the same cam, whereby they each release the same through-flow cross-section.

Moreover, it is preferably provided that the control member is a rotary valve, which includes at least one through-flow opening for at least one of the inlets, which may be brought into an overlap position with the inlet. Depending on the size of the overlap of the inlet and the through-flow opening, a through-flow cross-section is released. Due to the simpler design as a rotary valve, the mixing unit is configured to be more compact as compared to the approach including a camshaft. Due to the provision of multiple through-flow openings, each of which is assigned to at least one of the inlets and/or the outlet, in addition, a flexible configuration of the combination of the active agent liquid or active agent liquids with the carrier liquid is ensured.

According to one preferred refinement of the present invention, it is provided that at least two first inlets for the carrier liquid are present. As a result, it is possible to mix, in a simple way, a different quantity of carrier liquid with a certain active agent liquid, in particular with multiple existing active agent liquids, in order to set an optimal spray mixture, which is supplied through the outlet to the particular spray nozzle. Alternatively, in particular, only one first inlet is present. Moreover, it is preferably provided that the mixing unit is located upstream from a spray nozzle, in particular a field sprayer, or multiple spray nozzles or field sprayers. If the mixing unit is located upstream from a spray nozzle, and if the spray device preferably encompasses multiple spray nozzles, a separate mixing unit is located upstream from each spray nozzle, whereby an individual admixing of carrier liquid and active agent liquid takes place at the spray nozzle itself, whereby, on the one hand, an advantageous mixing is achieved and, on the other hand, the volume, which must be rinsed out during a cleaning, is minimized and, in addition, the function of a single nozzle shut-off may be implemented by the mixing unit itself. If the mixing unit is located upstream from multiple spray nozzles, in particular a so-called partial width of spray nozzles, these are all acted upon with the desired ratio of active agent liquid or active agent liquids and carrier liquid by one and the same mixing unit.

According to one preferred refinement of the present invention, it is provided that a servomotor, in particular a position-controlled servomotor, preferably an electric motor, is assigned to each control member of the mixing unit for the displacement thereof. With the aid of the servomotor, a simple and prompt displacement of the control member and, therefore, a prompt setting of the particular desired through-flow cross-section or mixing ratio is settable. Preferably, the servomotor and/or the control member coupled thereto include(s) a detent unit or a self-locking unit. This ensures that, for the case in which the electric motor or the servomotor is not activated, the particular control member remains in the desired rotation position, in order to maintain the set through-flow cross-section or the set through-flow cross-sections and the desired mixing ratio. The detent unit may be implemented, for example, with the aid of ball detent seats and the self-locking may be achieved with the aid of a severely reduced gear unit between the servomotor and the control member. As a result, a current consumption is minimized, overall, during operation.

Moreover, the spray device preferably encompasses one or multiple active agent liquid tanks, as well as at least one carrier liquid tank. Preferably, pump units are assigned to each of the active agent liquid tanks and to the carrier liquid tank, which deliver the particular liquid in the direction of the mixing unit as necessary.

The present invention is to be explained in greater detail below with reference to the figures.

### BRIEF DESCRIPTION OF THE DRAWINGS

FIG. 1 shows an advantageous spray device for deploying liquids for agricultural purposes in accordance with an example embodiment of the present invention.

FIG. 2 shows an advantageous mixing unit of the spray device in accordance with the present invention in a simplified detailed view.

FIG. 3 shows an advantageous refinement of the mixing unit in a simplified representation.

FIG. 4 shows one further exemplary embodiment of the spray device.

FIG. 5 shows an alternative exemplary embodiment of the spray device.

FIG. 6 shows one further exemplary embodiment of the advantageous mixing unit.

### DETAILED DESCRIPTION OF EXAMPLE EMBODIMENTS

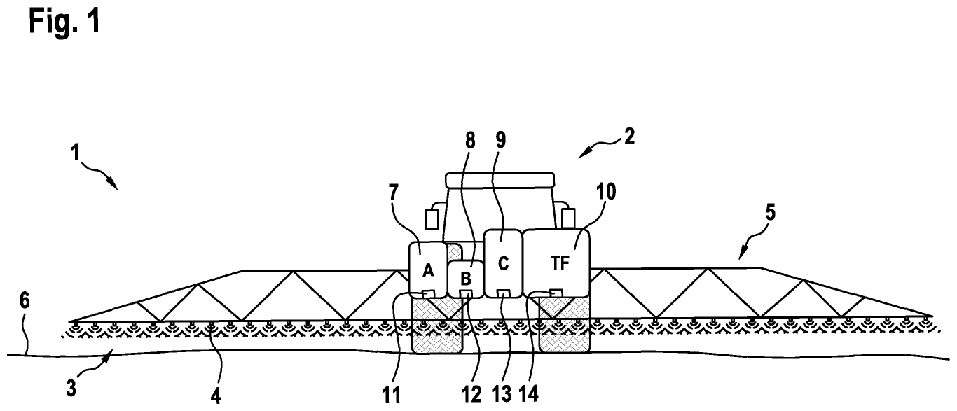

FIG. 1 shows, in a simplified representation, an example spray device 1, which encompasses a vehicle 2 designed as a tractor, which carries a spray system 3, including a plurality of spray nozzles 4, the spray nozzles 4 being distributed, next to one another, over a crossbar 5. Vehicle 2 pulls crossbar 5 and spray nozzles 4 behind itself, so that spray nozzles 4 are situated above a ground 6, in order to apply plant protection agent onto the ground and plants possibly located thereon.

For this purpose, vehicle 2 carries multiple tanks 7, 8, 9 and 10, a liquid active agent A, B, and C, in particular prediluted with a carrier liquid, being kept available in tanks 7, 8 and 9, respectively, and a carrier liquid TF, in particular water, being kept available in tank 10. The predilution is alternatively carried out/implemented with the aid of a premixing unit located upstream from the mixing unit. Tanks 7 through 10 are connected to spray nozzles 4 with the aid of one or multiple mixing units, which are to be discussed in greater detail in the following. In order to deliver the particular liquid, a pump unit 11, 12, 13 and 14 is assigned to each tank, with the aid of which the particular liquid is removable and suppliable to the mixing unit described below. While three different active agent product tanks 7, 8 and 9 are shown and described in the following exemplary embodiment, it goes without saying that spray device 1 may also encompass more or fewer active agent tanks 7, 8, 9.

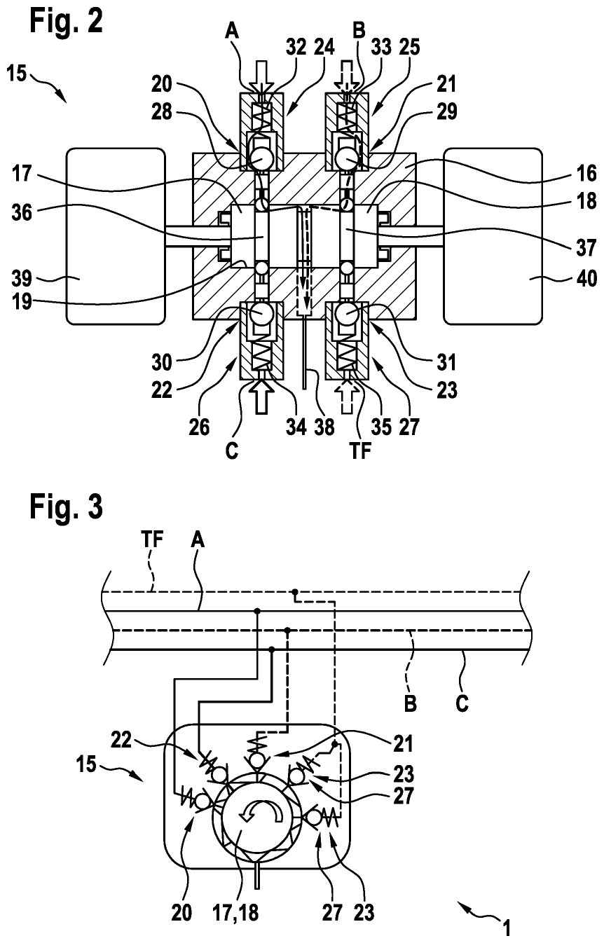

FIG. 2 shows, in a simplified sectional representation, aforementioned advantageous example mixing unit 15. Mixing unit 15 includes a housing 16, in which two control members 17, 18 are rotatably mounted. For this purpose, housing 16 provides a mixing chamber 19, in which control members 17, 18 are situated. Mixing chamber 19 is designed, in particular, in the shape of a cylinder, so that mixing chamber 19 itself preferably forms a pivot bearing, in particular a sliding bearing, for control members 17, 18. Housing 16 also includes multiple inlets 20, 21, 22 and 23. Inlets 20 through 23 empty into mixing chamber 19, a valve 24, 25, 26 and 27 being assigned to each of inlets 20 through 23. Due to particular valve 24 through 27, inlets 20 through 23 are connectable to liquid lines connected to pump devices 11, 12, 13, 14.

Valves 24 through 27 are designed as seat valves, which each include a valve element 28, 29, 30 and 31 mountable radially with respect to the rotational axis of mixing chamber 19. Valve elements 28 through 31 are each actuatable with the aid of control members 17, 18 counter to the force of a preload spring 32, 33, 34, 35. Particular preload spring 32 through 35 pushes valve element 28 through 31, in the direction of control member 17 or 18 into a valve seat of valve 24 through 27, in order to sealingly close inlet 20 through 23.

Control members 17, 18 are designed, in this case, as camshafts, which each include a cam 36 or 37, with the aid of which two of the valves 24, 26 or 25, 27, positioned radially opposite one another, are actuatable. For this purpose, cams 36 and 37 each interact with a valve stem of particular valve element 28 through 31. Due to the cams, the particular valve elements 28 through 31 may be pushed out of the particular valve seat counter to the force of the preload spring, so that a through-flow cross-section is released in each case, which makes it possible for liquid delivered to particular inlet 20 through 23 to penetrate mixing chamber 19.

Depending on the rotation position of particular control member 17, 18, a through-flow cross-section is therefore released, which permits the penetration of the particular liquid into mixing chamber 19, liquids being mixed with one another within mixing chamber 19. Through an outlet 38 formed in housing 16, the commingled mixture or the spray mixture produced in this way flows out of mixing unit 15 and to one or several of the aforementioned spray nozzle(s) 4.

In order to displace particular control member 17, 18 or the camshaft, it is provided that a separate servomotor 39 or 40 is assigned to each control member 17, 18. Servomotors 39, 40 are preferably designed as electric motors, which are coupled to control member 17, 18, or to the particular camshaft directly or with the aid of an, in particular, self-locking gear unit. Optionally, a detent unit, such as a ball detent unit, may be assigned to each of the control members 17, 18 and/or servomotors 39, 40, which prevents an undesirable displacement of control member 17, 18.

FIG. 3 shows mixing unit 15 according to a first exemplary embodiment in a schematic representation. Optionally, two of the inlets 23 or valves 27 are provided, through which the carrier liquid is suppliable to mixing chamber 19. In addition, the lines for various liquids A, B, C and TF are shown, simplified, in FIG. 3. With the aid of the displacement of the camshafts, the different through-flow cross-sections are settable, in order to achieve a desired mixing ratio. Preferably, the active agent liquids have already been premixed with carrier liquid in tanks A, B, C, in order to provide for an optimal mixing ratio during operation, or the active agent liquids are prediluted with the carrier liquid with the aid of a premixing unit, which is located upstream from mixing unit 15.

The profiles of cams 36, 37 of the camshaft are configured in such a way that one or multiple valve(s) 24 through 27 is/are opened and closed depending on the rotation angle of the particular camshaft.

With the aid of mixing unit 15 shown in FIG. 2, in particular, the switching positions listed in the following may be represented:

1.: active agent liquid A+carrier liquid water

2.: active agent liquid B+carrier liquid water

3.: active agent liquid C+carrier liquid water

4.: active agent liquids A and B+carrier liquid water

5.: active agent liquids A and C+carrier liquid water

6.: active agent liquids B and C+carrier liquid water

7.: active agent liquids A and B and C

8.: mixing unit closed in its entirety

In the case of a typical application of active agent liquids or plant protection agents, it is necessary to be able to adjust the total application rate. For example, the total quantity of water should remain constant during the changeover from, for example, one of the plant protection agents to a combination of multiple plant protection agents. Additionally, a pressure matched to the utilized nozzle and, therefore, a volumetric flow rate, should be set. The reason therefor is that a drop size spectrum, which is optimal for the application of plant protection agent, results at spray nozzle 4 only in the case of a pressure matched to the nozzle and, therefore, a predetermined volumetric flow rate. In one variation of the composition of the spray mixture, as shown, for example, in the aforementioned list, it is therefore also necessary that the total application rate for all intended combinations is identical to the quantity matched to particular nozzle 4. Therefore, the metered quantity of water or carrier liquid made available in mixing unit 15 varies depending on the selected mixing combination of active agent liquids. For example, less water needs to be metered for switching positions 1 through 3 than for switching positions 4 through 6. For switching position 7, no water, or less water than for switching positions 1 through 6, needs to be metered. The control of the quantity of water depending on the mixing combination is preferably implemented with the aid of the variable through-flow cross-section of valve 27, through which the carrier liquid is supplied. As one further possibility for quantity control, it is advantageous to implement the variation of the carrier liquid quantity with the aid of multiple individual valves 27. This possibility is outlined in FIG. 3. The two valves 27 may be switched together or independently of one another, in order to provide for an optimal metering of the carrier liquid.

As one further option for holding the quantity of water nearly constant, the dilution of the plant protection agents is preferably kept as low as possible. If, for example, the plant protection agent is diluted, in each case, with only 5% of the quantity of water to be deployed, then 90% of the total quantity of water could be constantly metered, when a nozzle is open, via the water path. Therefore, the range of the total quantity of water deployed would be 95% (upon utilization of one plant protection agent) up to 105% (upon utilization of three plant protection agents A, B and C).

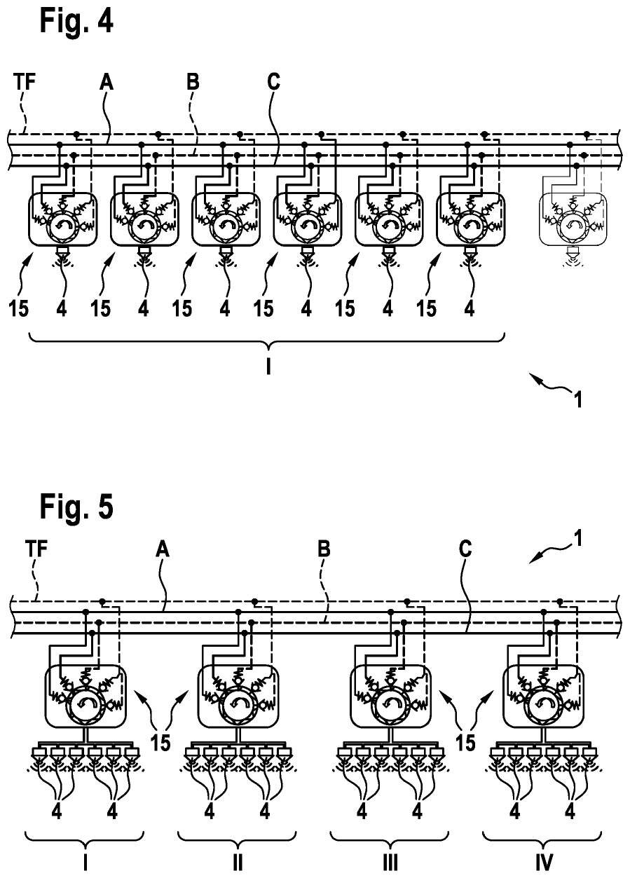

Advantageous mixing unit 15 may be integrated into the spray system or spray device 1, as shown in FIG. 1, in different ways. FIG. 4 shows a first exemplary embodiment for this purpose. It is provided that a mixing unit 15 is located upstream from each spray nozzle 4 or each spray nozzle 4 of a predetermined partial width I out of a predetermined number of selected spray nozzles 4, so that the mixing takes place directly upstream from particular spray nozzle 4. With the aid of this system, it is possible to specify the composition of the spray mixture separately for each spray nozzle 4.

Alternatively, the mixing unit, as represented in FIG. 5, may be integrated into spray device 1, it being provided, in this case, that one mixing unit 15 is located upstream from multiple spray nozzles 4 in each case, in particular spray nozzles 4 of a separate partial width I, II, III or IV of existing spray nozzles 4, so that the same composition of the spray mixture may be applied to multiple spray nozzles 4. If individual spray nozzles are to be switched on or off, actuatable switching valves are preferably assigned thereto.

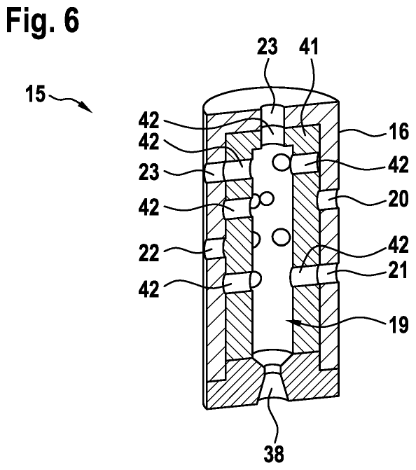

FIG. 6 shows one further exemplary embodiment, which differs from the exemplary embodiment from FIG. 2 in that mixing unit 15 includes a rotary valve 41, rather than one or multiple camshafts, in mixing chamber 19. Rotary valve 41 encompasses multiple through-flow openings 42, each of which may be brought into an overlap position with one of the inlets 20 through 23 depending on the rotation position of rotary valve 41, a through-flow cross-section being released, in each case, depending on the overlap position, and, therefore, the particular inlet being partially or completely opened. The liquid flows are mixed within the rotary valve 41, which is designed in the shape of a sleeve, and are supplied to outlet 38, which is axially situated in this case. In this case as well, a servomotor, of the type described above, is preferably utilized as an actuator for turning rotary valve 41. Depending on the rotation position of rotary valve 41, certain inlets are therefore released or opened, and therefore, a mixing ratio of plant protection agent A, B, C and carrier liquid TF is set. In addition, instead of a rotary valve 41, two rotary valves 41 may be situated one behind the other, to each of which a servomotor is assigned, in order to achieve a higher variance in the selection of the mixing ratios.

In addition to multiple radial inlets 20 through 23 and an axial outlet 38 shown in FIG. 6, the following variants may also be implemented: Mixing unit 15 including a rotary valve 41, encompassing multiple axial inlets and one radial outlet, encompassing multiple axial inlets and one axial outlet, or a mixture thereof.

Due to the advantageous embodiment of spray device 1, a compact and easily handleable mixture of desired active agent liquids with a carrier liquid in a small installation space is ensured.

1-14. (canceled)

15. A spray device for deploying liquids for agricultural purposes, the spray device comprising:
at least one spray nozzle for spraying the liquid; and
at least one mixing unit including at least one mixing chamber, the mixing chamber including at least one first inlet for a carrier liquid, at least one second inlet for an active agent liquid, and at least one outlet, the mixing unit further including at least one control member for setting a mixing ratio of carrier liquid and active agent liquid, wherein the control member is rotatably mounted in the mixing chamber, a through-flow cross-section of at least the first inlet and/or the second inlet being set depending on a rotation position of the control member.

16. The spray device as recited in claim 15, wherein the control member is a camshaft and at least one of the first and second inlets includes a valve actuatable via the camshaft.

17. The spray device as recited in claim 15, wherein the valve includes a valve element which is movably mounted and spring-preloaded in a direction of the camshaft and rests tightly against a valve seat of the valve, wherein the valve element closes the at least one of the first and second inlets, in a state in which it is not actuated by the camshaft.

18. The spray device as recited in claim 15, wherein the control member is a camshaft, and wherein a valve, actuatable by the camshaft, is assigned to several inlets of the mixing chamber or to each of the inlets of the mixing chamber.

19. The spray device as recited in claim 15, wherein the at least one control member includes two control members rotatably mounted in the mixing chamber, an activatable servomotor being assigned to each of the control members to rotate the control members.

20. The spray device as recited in claim 19, wherein each of the two control members is a camshaft, wherein the mixing chamber includes several inlets each having a respective valve, at least two of the valves in each case, being assigned to each of the camshafts.

21. The spray device as recited in claim 20, wherein each of the camshafts includes at least one respective cam in each case for each assigned valve.

22. The spray device as recited in claim 20 wherein each of the camshafts includes one shared cam for the at least two assigned valves.

23. The spray device as recited in claim 15, wherein the control member is a rotary valve which includes at least one through-flow opening for at least one of the first and second inlets, the rotary valve configured to be brought into an overlap rotation position with the at least one of the first and second inlets.

24. The spray device as recited claim 15, wherein the at least one first inlet includes at least two first inlets for the carrier liquid.

25. The spray device as recited in claim 15, wherein the mixing unit is located upstream from a spray nozzle of the at least one spray nozzle, or multiple spray nozzles of the at least one spray nozzle, and wherein the spray nozzle is in a field sprayer.

26. The spray device as recited in claim 15, wherein a detent device and/or a self-locking gear unit is assigned to the control member.

27. The spray device as recited in claim 15, wherein the spray device includes one or multiple active agent liquid tanks, and one carrier liquid tank, which are connected to the mixing unit.

28. The spray device as recited in claim 26, wherein a pump device is assigned to the active agent liquid tank and to the carrier liquid tank for delivering liquid to the mixing unit.
